(19) United States
(12) Patent Application Publication
(10) Pub. No.: US 2026/0227937 A1
(43) Pub. Date: Aug. 6, 2026

(54) IMAGE FORMING APPARATUS, CONTROL METHOD FOR IMAGE FORMING APPARATUS, AND MEDIUM

(71) Applicant: CANON KABUSHIKI KAISHA, Tokyo (JP)

(72) Inventor: Yuki Narita, Chiba (JP)

(21) Appl. No.: 19/460,565

(22) Filed: Jan. 27, 2026

(30) Foreign Application Priority Data
Feb. 3, 2025 (JP) 2025-016287

(51) Int. Cl. G06F 3/12

(52) U.S. Cl. CPC G06F 3/1222; G06F 3/1238; G06F 3/1253; G06F 3/1267; G06F 3/1288

(57) ABSTRACT

An image forming apparatus performs user authentication through a cloud authentication server and receives a cloud print job from a cloud print server. The image forming apparatus generates setting information in which first and second attributes are set among attributes included in the user information. The first attribute is used as a job owner name of a cloud print job and the second attribute is used as a login user name. The apparatus generates, with reference to the setting information, account association information in which an attribute values of the first and the second attributes are linked to each other on a per-user basis, and replaces the job owner name of the cloud print job with the attribute value of the second attribute linked to the job owner name of the cloud print job in the account association information.

### BACKGROUND

### Field of the Technology

A technique of the present disclosure relates to an image forming apparatus that has, for example, a cloud authentication function and a cloud print service function, a control method therefor, and a medium.

### Description of the Related Art

A cloud print service exists as a conventional method of managing an image forming apparatus, where printing is performed through reception of print data via a cloud network without intervention of an intra-company local area network (LAN) and the like. In using this service, there are cases where a user account managed by the cloud print service and a user account managed by the image forming apparatus are different from each other. Even in such cases, a print job that exists in the cloud print service can be managed and printed based on account information of the image forming apparatus by providing a function of associating different pieces of account information with one another from a setting screen (Japanese Patent Laid-Open No. 2018-024181).

Also, in recent years, a cloud authentication service that uses such technologies as OAuth 2.0 and OpenID Connect is emerging. An identity provider (IdP), such as Microsoft®, realizes a cloud authentication service by providing authentication information necessary for accessing a cloud service and the like as an open API. Regarding an image forming apparatus, too, execution of authentication through an account managed by the cloud authentication service has become possible due to the use of a tenant of the cloud authentication service at the time of authentication. As a result, it has become possible to receive a cloud service only through the account managed by the cloud authentication service without associating account information of the cloud authentication service with account information of the image forming apparatus.

However, even when the image forming apparatus supports authentication by the cloud authentication service, there is a case where job owner name information of a print job obtained in the cloud print service does not match user information of a user who has been authenticated by the cloud authentication service.

For example, there is a case where the cloud authentication service is used at the time of authentication on a client terminal (e.g., a client PC) other than the image forming apparatus. In this case, a DisplayName attribute of the user that is managed by the cloud authentication service is referenced as a user name after authentication processing (i.e., after a login). Therefore, it is often the case that, in settings of the image forming apparatus as well, a DisplayName attribute is set as a login user name after authentication processing that is set for a login account, similarly to the client terminal.

On the other hand, a UserPrincipalName attribute (hereinafter, a UPN attribute) is used as a job owner name of a print job that is uploaded from the client terminal to the cloud print service.

Therefore, if the aforementioned setting is configured, a job owner name of a cloud print job that is uploaded to the cloud print service is a UPN attribute, while user information after authentication of the image forming apparatus is a DisplayName attribute. Accordingly, in a case where the DisplayName attribute and the UPN attribute registered with the cloud authentication service have different attribute values, a job owner name of a cloud print job of a certain user does not match a login user name of this user on the image forming apparatus. In this case, the image forming apparatus handles a cloud print job that is originally owned by a login user as a cloud print job of another user. This gives rise to the problem that a user who uses the image forming apparatus cannot carry out the cloud print service in an appropriate manner.

Note that in the above description, a DisplayName attribute, a UPN attribute, and the like supported by the active directory provided by, for example, a Windows server have been described as examples. However, the aforementioned issue is not limited to this, and can occur in a case where a user name for display and a user name for authentication are used in distinction from each other in a system in which a cloud authentication server performs unified management of user accounts. Note, display mentioned here is not limited to visual display, and also encompasses a non-visual case, like attachment to a message.

### SUMMARY

A technique of the present disclosure has been made in view of the above-described conventional example, and appropriately establishes user correspondence even in a case where a job owner name used in a cloud print service is different from a login user name of an image forming apparatus.

In view of this, the following configuration is proposed. According to an aspect of the present disclosure, provided is an image forming apparatus that performs user authentication through a cloud authentication server and receives a cloud print job from a cloud print server, the cloud authentication server performing user authentication based on user information, the image forming apparatus comprising: at least one memory storing instructions; and at least one processor that is in communication with the at least one memory and that, when executing the instructions, cooperates with the at least one memory to execute processing, the processing including: generating setting information in which a first attribute and a second attribute are set among attributes included in the user information, the first attribute being used as a job owner name of a cloud print job and the second attribute being used as a login user name; generating, with reference to the setting information, account association information in which an attribute value of the first attribute and an attribute value of the second attribute are linked to each other on a per-user basis based on the user information; and replacing the job owner name of the cloud print job with the attribute value of the second attribute linked to the job owner name of the cloud print job in the account association information.

The aforementioned configuration can appropriately establish user correspondence even in a case where a job owner name used in a cloud print service is different from a login user name of an image forming apparatus.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic diagram showing a system configuration.

FIG. 2 is a diagram showing a hardware configuration.

FIG. 3 is a diagram showing a software configuration and a data region managed by software.

FIG. 4 is a diagram showing an example of an authentication screen provided by an image forming apparatus.

FIG. 5A is a sequence diagram until a print job is input and printed.

FIG. 5B is a sequence diagram at the time of execution of printing of a print job in a forced hold state.

FIG. 6A is a diagram showing an example of a setting screen provided by the image forming apparatus.

FIG. 6B is a diagram showing an example of a setting screen for configuring settings that are referred to when the image forming apparatus executes authentication processing.

FIG. 6C is a diagram showing an example of a setting screen for configuring account association settings that are registered when the image forming apparatus executes cloud authentication processing.

FIG. 6D is a diagram showing an example of a pop-up screen inside an association setting screen provided by the image forming apparatus.

FIG. 7A is a flow diagram of authentication processing including automatic account association provided by the image forming apparatus.

FIG. 7B is a flow diagram of authentication processing including automatic account association provided by the image forming apparatus.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### System Configuration in Present Embodiment

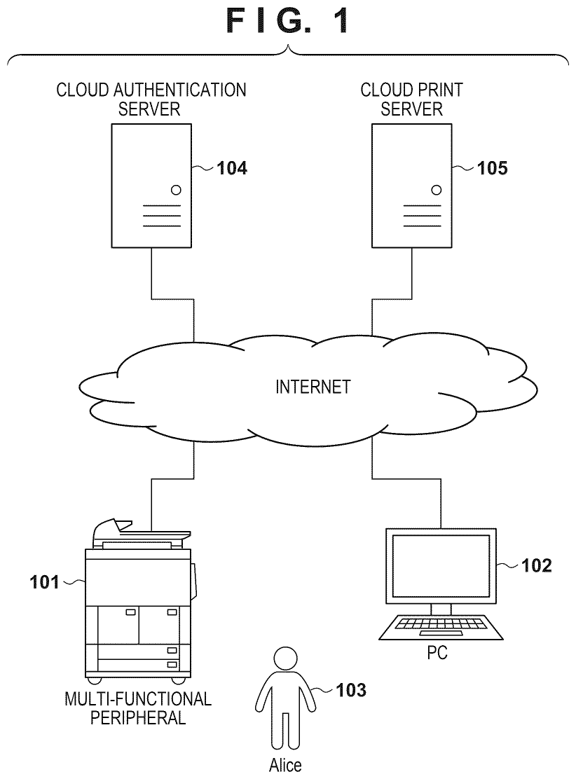

FIG. 1 shows an example of an image forming system according to the present embodiment, in which a multi-functional peripheral as an example of an image forming apparatus, a personal computer (PC) as an example of an information processing apparatus, and a cloud server are connected. A multi-functional peripheral 101, which has a printing function, includes network interfaces built therein, and can connect to two cloud services, namely a cloud authentication server 104 and a cloud print server 105, via these network interfaces. Furthermore, similarly to the multi-functional peripheral 101, a PC 102 also includes network interfaces built therein, and connects to two cloud services, namely the cloud authentication server 104 and the cloud print server 105, via these network interfaces.

Note that in the present embodiment, the multi-functional peripheral 101 and the PC 102 do not communicate with each other directly via the network interfaces, and a printer job is expected to be executed with use of a cloud print service.

Alice 103, a user who uses the multi-functional peripheral 101 and the PC 102, is a user who executes cloud authentication with respect to the multi-functional peripheral 101 when using the multi-functional peripheral, and executes cloud authentication with respect to the PC 102 when using the PC. It is assumed that both of the multi-functional peripheral 101 and the client terminal 102 receive a cloud authentication service that refers to the same user information from the same cloud authentication server 104.

The user, Alice 103, logs into the PC 102 and then transmits an execution-target print job, which is to be printed, to the cloud print server 105. Thereafter, the multi-functional peripheral 101 downloads the print job from the cloud print server 105 and executes the print job, thereby performing printing.

### Hardware Configuration in Present Embodiment

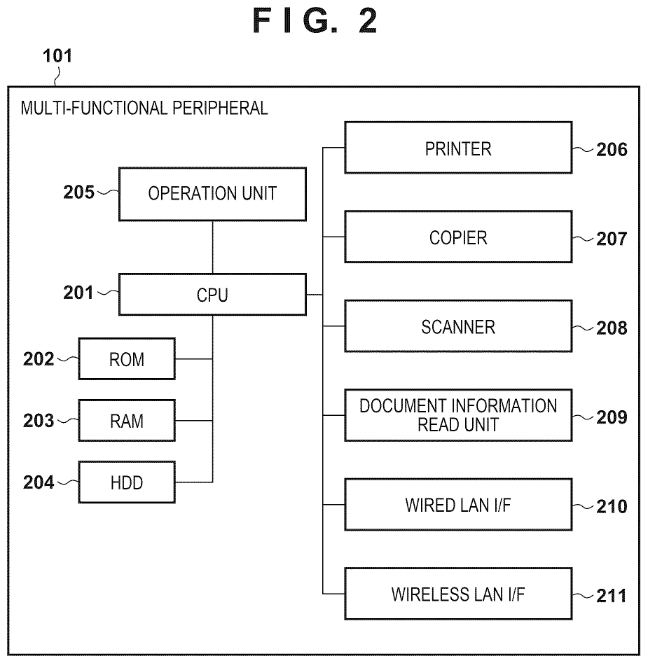

FIG. 2 is a hardware configuration diagram of the image forming apparatus (multi-functional peripheral 101) according to an embodiment. A CPU 201 controls the entirety of the apparatus by executing software programs of the multi-functional peripheral 101. A ROM 202 is a read-only memory, and stores a boot program, fixed parameters, and the like for the multi-functional peripheral 101. A RAM 203 is a random-access memory, and is used to, for example, store programs and temporary data when the CPU 201 controls the multi-functional peripheral 101. An HDD 204 is a hard disk drive, and stores system software, applications, and various types of data. The CPU 201 controls operations of this multi-functional peripheral 101 by executing the boot program stored in the ROM 202, loading programs stored in the HDD 204 to the RAM 203, and executing the loaded programs.

The multi-functional peripheral 101 includes a printer 206, a copier 207, a scanner 208, and additionally, a document information read unit 209 that reads information of a scanned document. Also, it includes an operation unit 205 that operates the multi-functional peripheral 101, as well as a wired LAN interface (I/F) 210 and a wireless LAN I/F 211. These are controlled by the CPU 201.

The printer 206 is a unit that realizes an image forming function, and executes processing for forming an image corresponding to a print job from the cloud print server received via, for example, the network interfaces, and outputting the image to a sheet. The scanner 208 is a unit that realizes a function of reading an image from an original; it optically reads an original image set on a scanner unit, and stores the read image as image data into the HDD 204, or transmits the same from the wired LAN I/F 210 or the wireless LAN I/F 211. The copier 207 executes processing for outputting the image data read by the scanner unit to a sheet with use of a printer unit.

The document information read unit 209 reads information (a barcode, a QR Code®, a background pattern, characters, etc.) embedded in the document scanned by the scanner 208, and stores the read information into the HDD 204.

The wired LAN I/F 210 and the wireless LAN I/F 211 connect to a communication network, and control transmission/reception of data when using a service that exists in a cloud, for example.

### Software Configuration in Present Embodiment

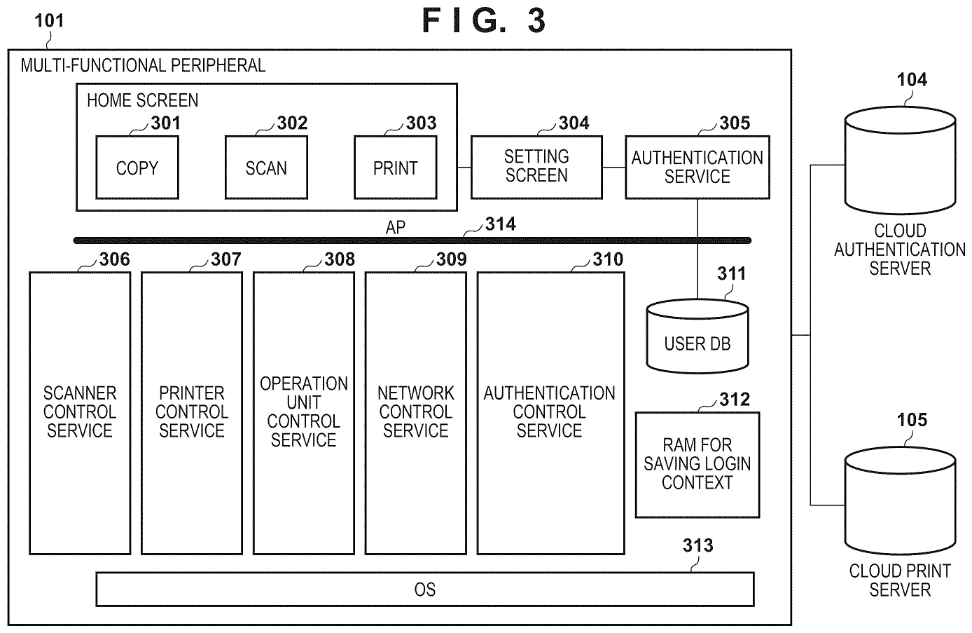

FIG. 3 is a software configuration diagram of the multi-functional peripheral 101. The multi-functional peripheral 101 of FIG. 3 includes copy 301, scan 302, print 303, a setting screen 304, and an authentication service 305 as applications that operate on a platform. Also, the aforementioned applications are activated by communicating with various types of control services via an application programming interface (API) 314. The various types of control services are a group of modules that include a scanner control service 306, a printer control service 307, an operation unit control service 308, a network control service 309 for a wired/wireless LAN and the like, and an authentication control service 310. Also, the multi-functional peripheral 101 includes a user database (user DB 311) that holds user information, and a RAM 312 for saving a login context, in which a login context of a user who has executed a login is saved.

The copy 301, scan 302, print 303, setting screen 304, and authentication service 305 provide user interfaces operable by a user.

The authentication service 305 provides a local authentication service function and a cloud server authentication service function for logging into the multi-functional peripheral 101. A cloud server authentication service is also called a cloud authentication service. A local authentication service is user authentication that is performed by the authentication control service 310 of the multi-functional peripheral 101 per se with reference to user information of the user DB 311. Furthermore, the authentication control service 310 manages login users by, for example, registering new users or changing user information for using the local authentication service with use of information of the user DB 311. Meanwhile, when executing the cloud server authentication service, the authentication control service 310 accesses the external cloud authentication server 104, and the cloud authentication server 104 executes authentication processing by referring to user information registered therewith. Note that although the user information may be stored in another server, it is assumed in the present example that the user information is held in the cloud authentication server 104.

These settings related to user management and various types of authentication can be set from the setting screen 304 after a user has logged into the multi-functional peripheral 101. The above-described various functions of the embodiment can be realized by programs described in a legacy programming language, an object-oriented programming language, or the like, and can be distributed while being stored in a machine-readable recording medium. For example, such programming languages include an assembly language, C, C++, Visual C++, Perl, and Ruby, as well as Java, JavaBeans, Java applets, and JavaScript that are registered trademarks of Oracle Corporation, among others.

### <User Account Authentication Service>

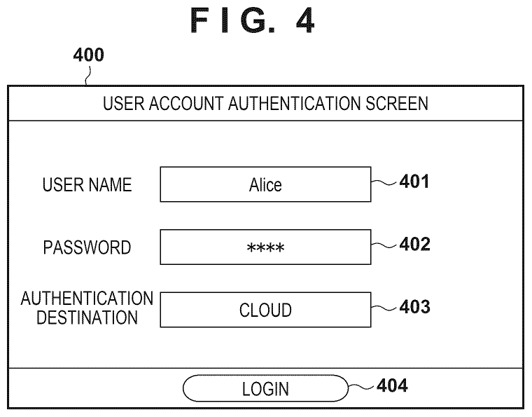

FIG. 4 shows an example of an authentication screen of a user account authentication service used in the local authentication service and the cloud server authentication service. The user account authentication service is an authentication service that authenticates a user through inputting of a user name 401 and a password 402 via a local UI of the multi-functional peripheral 101.

A user who uses the multi-functional peripheral 101 inputs a user name and a password to text fields that are displayed on the local UI. The user name and the password together are also referred to as authentication information. Specifically, the user inputs the user name 401 and the password 402 to their respective fields, selects an authentication destination 403, and then presses a login button 404. For example, it is permissible to adopt a configuration in which pre-registered authentication destinations are displayed as a pop-up, and the user selects an authentication destination from among them.

At this time, in a case where the authentication destination 403 is a local device, the local authentication service is selected, and registration of a user account corresponding to the input user name with the user DB 311 included in the multi-functional peripheral 101 is confirmed.

In a case where the authentication destination 403 is the cloud, the cloud server authentication service is selected, and the multi-functional peripheral 101 accesses the external cloud authentication server 104 and confirms whether the user account corresponding to the input user name has been registered.

Authentication processing succeeds in a case where information of the input user name and password is registered as the user account with the user DB 311 when the authentication destination is the local authentication service, and with the cloud authentication server 104 when the authentication destination is the cloud authentication service. In this case, the multi-functional peripheral 101 can be used. In a case where the user account equivalent to the input user name (or user identification information) does not exist, or an inconsistency in a password input or the like has occurred, it is considered that an authentication error has occurred and the user account authentication screen is displayed. Note that the user account mentioned here denotes information that is equivalent to information (record) of each user out of later-described user information. This information may include information that accompanies the user, such as user-by-user statistical information.

Furthermore, it is necessary to register the user information in advance with the user DB 311 when the local authentication service is used, and with the cloud authentication server 104 when the cloud server authentication service is used. Registration of the user information (referred to as user registration) is expected to be executed by an administrating user who is given the administrator authority in both authentication services.

<User Information Registered with Cloud Authentication Server>

Below, an example of user information registered with the cloud authentication server 104 is shown in Table 1.

TABLE 1
User information registered with the cloud authentication server

| Attribute 1: | Attribute 2: | Attribute 3: | | Role |
|---|---|---|---|---|
| UPN | DisplayName | givenName | Password | Information |
| Alice | Alice@dn | Alice@gn | ******** | Administrator |
| Bob | Bob@dn | Bob@gn | ******** | General |
| | | | | (printing |
| | | | | permitted) |
| Carol | Carol@dn | Carol@gn | ******** | General |
| | | | | (printing |
| | | | | permitted) |
| Dave | Dave@dn | Dave@gn | ******** | General |
| | | | | (printing |
| | | | | permitted) |
| Ellen | Ellen@dn | Ellen@gn | ******** | General |
| | | | | (printing |
| | | | | permitted) |

In the present embodiment, the user information includes an attribute 1, an attribute 2, an attribute 3, a password, and role information as shown in Table 1. Each of the attributes included in the user information shown in Table 1 is as follows.

Attribute 1 (UPN): A UPN is an attribute that is referred to when logging into the multi-functional peripheral 101 or the PC 102, and a user logs into the multi-functional peripheral 101 or the PC 102 with use of a user name of the UPN.

Attribute 2 (DisplayName): DisplayName is an attribute value that is, after logging into the multi-functional peripheral 101 or the PC 102, used as a displayed login user name on the multi-functional peripheral or the terminal, for example. It is assumed in the present embodiment that, when a user logs into the multi-functional peripheral 101 and the PC 102, login processing is executed using the attribute 1 (UPN), and the attribute 2 (DisplayName) is used as a display name of the user after the login, unless specifically stated otherwise.

Attribute 3 (givenName): Similarly to DisplayName, givenName can also be used as a login user name on each device after logging into the multi-functional peripheral 101 or the PC 102.

The role information of Table 1 indicates the authority of the user after logging into the multi-functional peripheral 101, and it is assumed that each type of setting of the multi-functional peripheral 101 and the like can be executed by a user for whom administrator has been set as the role information, that is to say, a user who is given the administrator authority. The role information may also be referred to as authority information.

The password is information that composes authentication information together with a user name; at the time of authentication, a password that is registered in user information in correspondence with a user name (UPN) input by the user is verified against a password input by the user.

Note that user information that is held in the user DB 311 for the local authentication service may also be similar to Table 1. In this way, authentication can be performed through similar authentication processing simply by changing the authentication destination, and furthermore, common processing can be executed also with regard to other types of processing that use user information.

### <Account Association Information>

Below, an example of account association information managed by the multi-functional peripheral 101 is shown in Table 2. The account association information may be saved in, for example, the user DB 311. The account association information is information indicating correspondence between a user name of a login user of the multi-functional peripheral 101 or the PC 102 (a login user name) and a user name of the cloud print service, that is to say, a job owner name of an uploaded print job.

TABLE 2
Account association information managed
by the multi-functional peripheral

| | | User Name of |
|---|---|---|
| Login User Name | Server Name | Cloud Print Service |
| Alice@dn | Cloud | Alice |
| Bob@dn | Cloud | Bob |
| Carol@dn | Cloud | Carol |
| Dave@dn | Cloud | Dave |
| Ellen@dn | Cloud | Ellen |

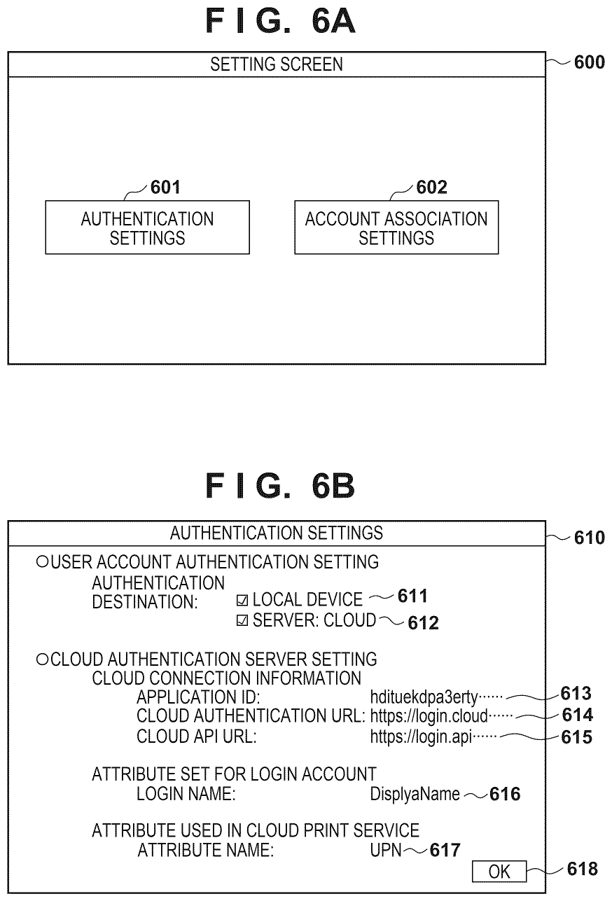

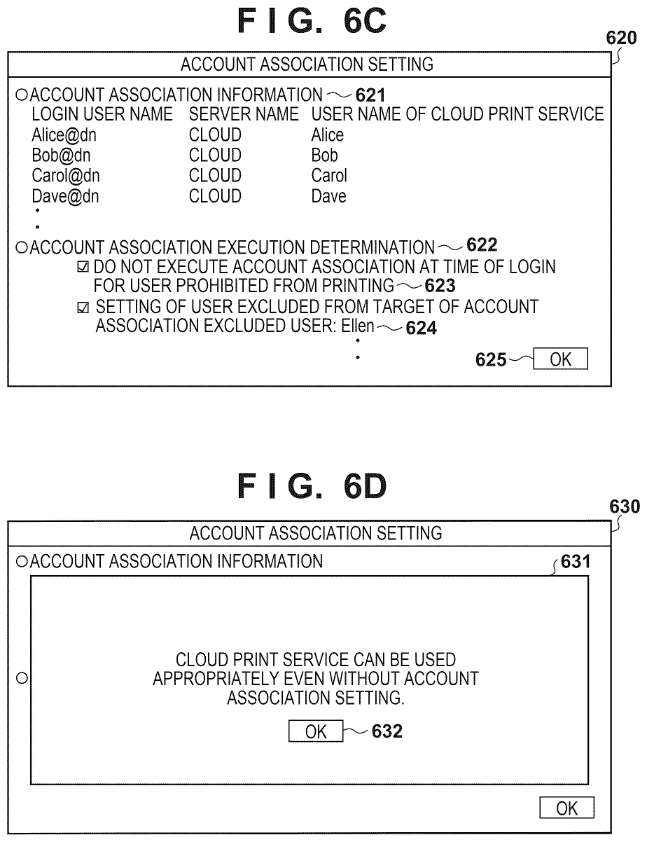

The login user name of Table 2 shows a value that is referenced as a user name of a user after the user has logged into the cloud authentication service. In this example, the DisplayName attribute in the user information of Table 1 is set as the login user name. The user name of the cloud print service shows a value of a job owner name that is given at the time of execution of cloud printing. The job owner name is, for example, a user name that is given to a cloud print job by the PC 102 or the like. In this example, the UPN attribute in the user information of Table 1 is set as the user name of the cloud print service. The server name shows the name of the cloud authentication service at the time of use of the cloud authentication service. In a case where the account association information of Table 2 is registered on the multi-functional peripheral 101 side, for example, when the user Alice has executed cloud printing from the PC 102, “Alice” is given to a cloud print job as the job owner name of the print job. Then, on the multi-functional peripheral 101 that has obtained this cloud print job, the job owner name is converted (or replaced) from “Alice” into the corresponding login user name “Alice@dn”. A setting of what kind of value is to be applied to each field of the account association information has been configured on an authentication setting screen of later-described FIG. 6B and saved.

Note that although the aforementioned account association information is automatically generated upon login to the multi-functional peripheral 101 in the present embodiment, an administrator or a general user who uses the multi-functional peripheral 101 may manually register the account association information.

### <Setting Screens Provided by Image Forming Apparatus>

FIG. 6A to FIG. 6E show examples of setting screens provided by the multi-functional peripheral 101, which is the image forming apparatus. FIG. 6A shows an exemplary configuration of a setting screen 600 displayed on the operation unit 205 of the multi-functional peripheral 101. The setting screen 600 is intended for a user to issue instructions about authentication settings and account association settings. This setting screen 600 per se does not include specific setting items, and is an intermediate layer that acts as a guide to detailed setting items. When an authentication setting button 601 has been pressed, an authentication setting screen 610 shown in FIG. 6B is displayed. When an account association setting button 602 has been pressed, an account association setting screen 620 shown in FIG. 6C is displayed.

FIG. 6B shows an exemplary configuration of the authentication setting screen 610 according to the present embodiment, and settings that are referred to when the multi-functional peripheral 101 executes authentication processing can be configured on the authentication setting screen 610. In a field for setting user account authentication on the multi-functional peripheral 101, whether to set only a local device 611, or both of the local device 611 and a server 612, as the authentication destination of the multi-functional peripheral 101 can be configured. In a case where both of them are set, the order of use may be designated or fixed. The authentication destination denotes, for example, equipment or an agency that performs user authentication, such as an apparatus and a module. Here, in a case where the server 612 is set as the authentication destination, identification information of the server is also set together. For example, in a case where the cloud authentication server 104 is to be used, “cloud” is set. This is an example, and it is also possible to designate an on-premise authentication server. Furthermore, in a case where a network has crashed or the counterpart server does not respond at the time of server authentication, the local device 611 is set to be always enabled in order to prevent the user from becoming unable to log into the multi-functional peripheral 101.

In a case where the server 612 is set as the authentication destination and the “cloud”, namely the cloud authentication server 104 is set as this server, settings related to the cloud authentication server that is the connection destination can be configured continuously. The settings related to the cloud authentication server include three items, namely cloud connection information, information set for a login account, and an attribute used in the cloud print service; a setting(s) is configured in connection with each item.

Settings of an application ID 613, a cloud authentication URL 614, and a cloud API URL 615 exist as the cloud connection information. The application ID 613 is a unique ID issued by the counterpart cloud authentication server 104. At the time of cloud authentication, giving the application ID 613 as authentication information to a transmission packet enables the cloud authentication server 104 to detect that a transmission source thereof is a registered application. The application ID 613 may be obtained via communication from the cloud authentication server 104, or may be obtained offline.

The cloud authentication URL 614 is an authentication URL at the time of access to the cloud authentication server, and is referenced as a URL of an access destination when the multi-functional peripheral 101 uses the cloud authentication service. The cloud API URL 615 is a URL which is used in processing for obtaining user information after the execution of cloud authentication, and which is provided by the cloud authentication server 104. A user name, authority information, and the like of a user who has executed cloud authentication can be obtained by accessing the URL set as the cloud API URL 615 in a state where a transmission packet has been given an access token that is obtained after the cloud authentication has succeeded.

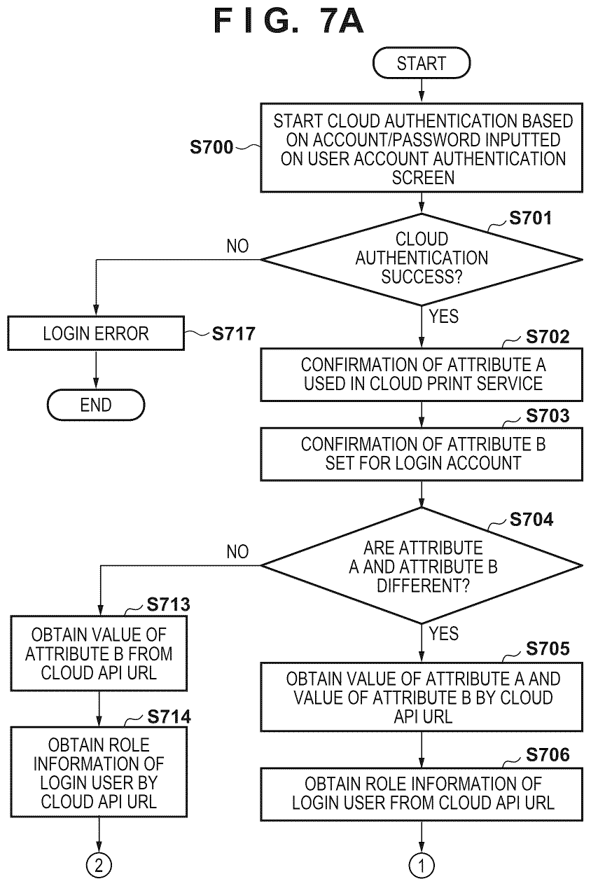

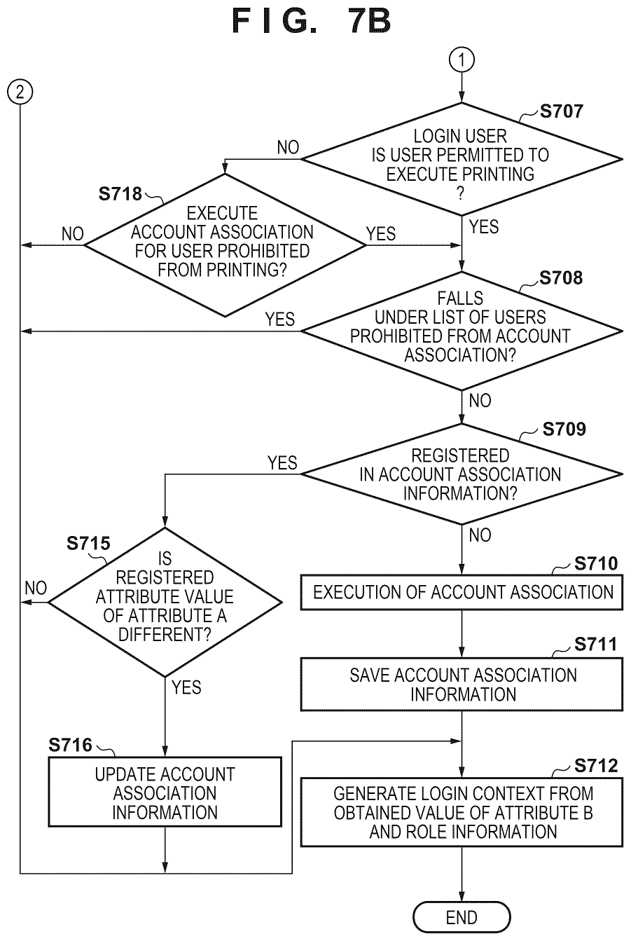

The attribute 616 set for the login account is an item for setting from which attribute, in user information held in the cloud authentication server 104, a login user name managed inside the multi-functional peripheral 101 has been obtained after cloud authentication has succeeded. The attribute of the user information shown in Table 1 that is registered in a field of the login user name in the account association information of Table 2 is set as the attribute 616 set for the login account when the account association information is generated in a procedure of later-described FIGS. 7A and 7B. Note, in many cases, “DisplayName” is normally set so as to match the login name displayed on the PC 102; however, “UserPrincipalName” can also be set as this setting. By setting a UPN as this setting, a print job can be managed accurately even in a case where a job owner name transmitted from the cloud print service and a login user name who has logged into the multi-functional peripheral 101 match, and there are no account association settings. Conversely, when the DisplayName attribute is used as a login user name, a job owner name of a print job obtained from the cloud print service and a login user name who has logged into the multi-functional peripheral 101 do not match. This is because the UPN attribute is used as the job owner name of the print job obtained from the cloud print service. In this case, if the same attribute as a login user name of the PC 102 is used as a login user name of the multi-functional peripheral 101, a job owner name of a cloud print job and a job owner name of a print job that has been obtained directly from the PC 102 still do not match. In this case, executing the account association makes it possible to establish correspondence between user names that do not match otherwise.

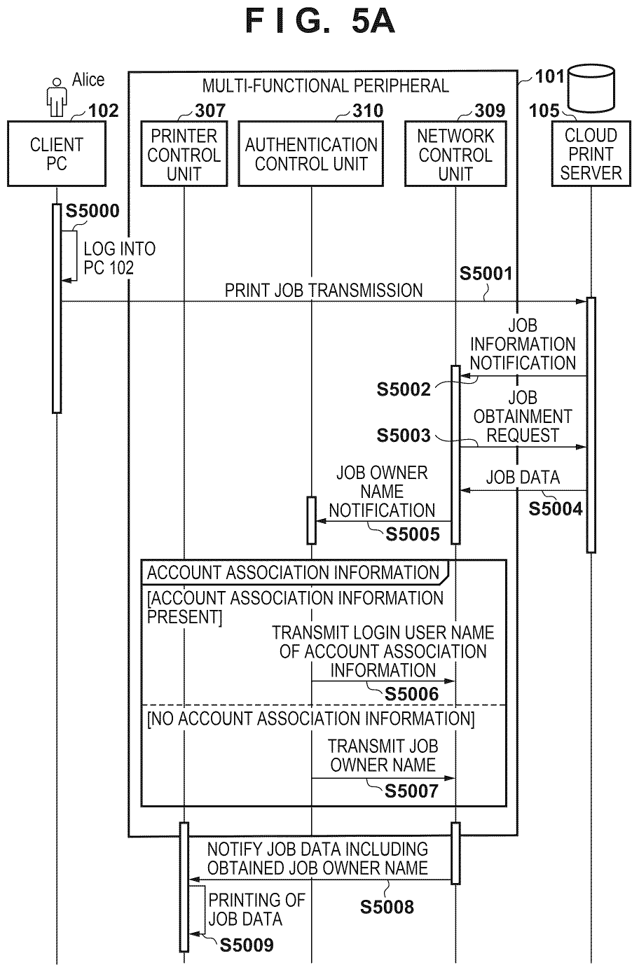

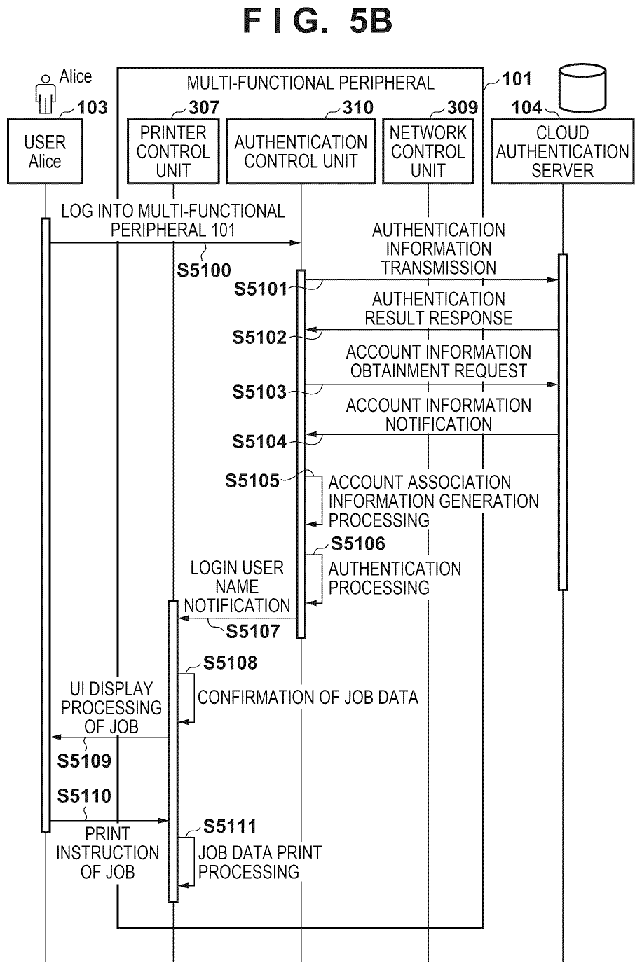

The attribute 617 used in the cloud print service is an item for saving information indicating an attribute used in the cloud print service, which is indicated by a job owner name notification (S5005) shown in later-described FIG. 5A. Although a setting value of this item is updated through a notification from the network control service 309 in step S5005 of FIG. 5A, an administrating user may set attribute information used in the cloud print service in advance. The attribute 617 used in the cloud print service is the attribute of the user information shown in Table 1 that is registered in a field of the user name of the cloud print service in the account association information of Table 2 when the account association information is generated in the procedure of later-described FIGS. 7A and 7B.

When an OK button 618 has been pressed after the completion of settings on the authentication setting screen of FIG. 6B, the setting value(s) that has been set for each item is saved in the RAM 203, ROM 202, or HDD 204, and the setting screen 600 is displayed back again. The setting values of the items saved here are referred to when the cloud authentication server 104 authenticates the user of the multi-functional peripheral 101, and when the account association information is generated or updated in the procedure of FIGS. 7A and 7B.

FIG. 6C shows an exemplary configuration of an account association setting screen 620 according to the present embodiment. This is an example in which the account association information of Table 2 is displayed. On the account association setting screen 620, the account association information that is registered when the multi-functional peripheral 101 executes cloud authentication processing can be referred to, and settings of account association can be configured. In the account association information 621, a user name of the cloud print service and a login user name of the multi-functional peripheral 101 to be associated therewith can be set automatically or manually as has been described in relation to Table 2. Processing for adding, changing, or deleting the account association information can also be executed from this setting.

Account association execution determination 622 is a setting item for selecting a target for which account association is to be performed automatically at the time of cloud authentication. In the case of a user who is prohibited from printing, if an setting 623 indicating that “account association is not executed upon login of a user who is prohibited from printing” is set to be enabled, the multi-functional peripheral 101 executes only cloud authentication processing and does not execute account association. For example, the user Ellen shown in Table 1 is a user who is prohibited from printing; therefore, if the setting 623 is set to be enabled, when she executes cloud authentication from the multi-functional peripheral 101, she can log in, but association information is not automatically registered in the account association information.

Also, in a case where a setting 624 of users excluded from targets of account association is enabled, a user who is presented under this setting can log in when he/she wishes to execute cloud authentication from the multi-functional peripheral 101, but association information is not automatically registered in the account association information, similarly to the aforementioned setting.

When an OK button 618 has been pressed after the completion of settings, the setting value(s) that has been set for each item is saved in the RAM 203, ROM 202, or HDD 204, and the setting screen 600 is displayed back again. When the cloud authentication server 104 authenticates a user of the multi-functional peripheral 101, especially during account association processing, the setting values of the items that have been saved here are referred to and reflected in the operations of the multi-functional peripheral 101.

A pop-up screen 631 inside an account association setting screen 630 shown in FIG. 6D is displayed when an administrating user or a general user has manually executed the account association settings in a case where the setting value of the attribute 616 set for the login account of FIG. 6B is a UPN. Even when the account association settings have not been executed, the pop-up screen 631 is displayed to notify the user of the same in a case where the cloud print service can be appropriately used. This can suppress the user's execution of unnecessary settings. A case where the cloud print service can be used appropriately even when the account association settings have not been executed is, for example, a case where a login user name is a UPN. In this case, both the login user name and a job owner name of a print job that is not a cloud print job are UPNs, and conversion of a user name becomes unnecessary. A state where the cloud print service can be used appropriately even when the account association settings have not been executed can be determined, for example, based on a state where the attribute 616 set for the login account and the attribute 617 used in the cloud print service are the same attribute.

### Description of Flow According to Present Embodiment

Next, using a flowchart of FIGS. 7A and 7B, a description is given of a flow that is executed by the CPU 201 in the image forming apparatus 101 of the present embodiment loading a program stored in a region of the ROM 202 to the RAM 203.

The flowchart of FIGS. 7A and 7B is described in relation to account association during use of the cloud authentication service. Also, the flowchart is described in relation to updating of the account association information that is necessary to deal with a case where an administrating user has changed a setting value of the attribute 616 set for the login account shown in FIG. 6B, that is to say, an attribute of a login user name, during actual management. Furthermore, this update is also applicable to a case where the administrating user has changed an attribute value of a general user registered with the cloud service. Processing of FIGS. 7A and 7B is executed when, for example, a user who has logged into the multi-functional peripheral 101 has input an instruction from the operation unit 205 in order to register him/herself with the account association information.

### <Flow of Account Association Processing During Use of Cloud Authentication Service>

In step S700, the CPU 201 of the multi-functional peripheral 101 executes cloud authentication based on a user name and a password input from a user account authentication screen 400. At the start of cloud authentication, the cloud authentication server 104 is accessed based on setting information of the application ID 613 and the cloud authentication URL 614 shown in FIG. 6B. After the execution of access processing, the CPU 201 determines whether an authentication response has been received from the cloud authentication server 104 and the authentication has succeeded in step S701. In a case where an account corresponding to the user name input here is unclear, or in a case where the cloud authentication has failed because, for example, the input password is different from the one held in the authentication service, it is determined that a login error has occurred. In this case, the CPU 201 of the multi-functional peripheral 101 displays a login error for a user in step S717, and ends processing.

The CPU 201 of the multi-functional peripheral 101 that has received an authentication success response refers to a setting value of an attribute used in the cloud print service (hereinafter, an attribute A) in step S702. Here, the attribute A has been set and saved in advance as the attribute 617 used in the cloud print service as shown in FIG. 6B; therefore, it is sufficient to refer to a setting value thereof. Alternatively, an inquiry about the attribute A may be made to the network control service 309. The attribute A may be referred to as a first attribute.

Next, in step S703, the CPU 201 of the multi-functional peripheral 101 refers to a setting value of the attribute 616 set for the login account (hereinafter, an attribute B), which is set in FIG. 6B. As the attribute 616 has also been set and saved on the setting screen of FIG. 6B, it is sufficient to refer to a setting value thereof. The attribute B may be referred to as a second attribute.

In step S704, the CPU 201 determines whether the attribute A and the attribute B are different from each other. In a case where it has been determined in step S704 that the attribute A and the attribute B are different from each other, that is to say, their attribute names are different, the CPU 201 of the multi-functional peripheral 101 judges that it is necessary to execute account association. In the example of FIG. 6B, the attribute A is UPN and the attribute B is DisplayName, and they are different from each other. In this case, in step S705, the CPU 201 accesses the URL set as the cloud API URL 615 shown in FIG. 6B, and executes processing for obtaining an attribute value of the attribute A and an attribute value of the attribute B from user information of the login user. In the example of FIG. 6B, as the attribute A is DisplayName and the attribute B is UPN, their respective attribute values included in the user information of the login user are obtained from the cloud authentication server 104. For example, when the user is Alice, Alice@dn and Alice are respectively obtained as the values of the attribute A and the attribute B from the user information of Table 1.

In step S706, the CPU 201 of the multi-functional peripheral 101 accesses the URL set as the cloud API URL 615, and obtains role information of the login user.

In step S707, the CPU 201 determines whether the login user is a user who is permitted to execute printing from the obtained role information. The role information indicates whether this user is a user who is permitted to execute printing. In a case where the current login user has been determined to be a user who is permitted to execute printing, processing branches to step S708; in a case where the current login user is not a user who is permitted to execute printing, processing branches to step S718.

In step S708, the CPU 201 of the multi-functional peripheral 101 determines whether the login user is a user excluded from targets of account association. Here, the login user is determined to be excluded from targets of account association in a case where the “setting of users excluded from targets of account association” 624 on the account association setting screen 620 is set to be enabled and the user name of the login user is registered under this setting 624. If the login user is a user who is a target of account association, processing branches to step S709; otherwise, processing branches to step S712.

On the other hand, in a case where the login user has been determined to be a user who is not permitted to execute printing in step S707, the CPU 201 determines whether to execute account association for the user who is prohibited from printing, that is to say, the user who has been determined to be unable to execute printing, in step S718. Here, if the setting 623 indicating that “account association is not executed upon login of a user who is prohibited from printing” on the account association setting screen 620 is set to be enabled, it is determined that the login user is not a target of account association. If it is determined that the login user is not a target of account association, processing branches to step S712; otherwise, processing branches to step S708.

In a case where it has been determined in step S708 that the login user is a user excluded from targets of account association, the CPU 201 of the multi-functional peripheral 101 does not execute account association and generates a login context from the obtained value of the attribute B and role information in step S712, and ends login processing. The login context may be, for example, information in which identification information of the user who is currently logged in and his/her role information are associated with each other.

In a case where the login user has been determined to be a user who is a target of account association in step S708, the CPU 201 of the multi-functional peripheral 101 determines whether the account association information has already been registered for the login user in step S709. This determination is made by, for example, verifying the attribute value of the attribute A in the user information of the login user obtained in step S705 against the user name of the cloud print service of the login user in the account association information. Then, if the account association information includes a record indicating that they match, it is determined that this user has already been registered; otherwise, it is determined that this user has not been registered. Processing branches to step S715 if the user has already been registered, and to step S710 if the user has not been registered. In this case, the attribute A is used as information that links the user information to the account association information. Note that in step S709, whether the user has already been registered may be determined by, for example, verifying the attribute B obtained in step S705 against the login user name in the account association information. In this case, the attribute B is used as information that links the user information to the account association information.

In a case where the login user has not been registered with the account association information, the CPU 201 executes account association processing in step S710. In the account association processing, a record of the account association information corresponding to the login user is generated by using the values of the attribute A and the attribute B, which were obtained in step S705, as the user name of the cloud print service and the login user name in the account association information, respectively. Furthermore, the setting value of the server 612 that has been set as the authentication destination is used as the server name in the account association information. The record of the account association information that has been thus generated is added to the account association information shown in Table 2. After the execution of the account association processing, in step S711, the CPU 201 of the multi-functional peripheral 101 saves the account association information generated in step S710, which includes account association information corresponding to the login user that was added in step S710. After the account association information has been saved, the CPU 201 of the multi-functional peripheral 101 generates a login context from the obtained value of the attribute B and role information in step S712, and ends login processing.

On the other hand, in a case where it has been determined that the attribute names of the attribute A and the attribute B are the same in step S704, the multi-functional peripheral 101 judges that account association is unnecessary. In this case, in step S713, the CPU 201 obtains only the value of the attribute B from the cloud API URL 615 shown in FIG. 6B. At this time, the attribute A may be obtained in place of the attribute B. Thereafter, in step S714, the CPU 201 obtains role information of the login user. Thereafter, processing branches to step S712, a login context is generated, and login processing is ended.

### <Flow for Updating Account Association Information>

In a case where it has been determined in step S709 that the login user has already been registered with the account association information, processing of step S715 onward is executed. In this processing flow, the account association information is updated in, for example, a case where the administrating user has changed the attribute 616 set for the login account shown in FIG. 6B, or has changed an attribute value of the user information. A description is now provided in relation to, for example, account association information update processing that is required in a case where the attribute value of DisplayName described in Table 1 has been changed from Alice@dn to Alice@dn2.

Assume a case where the attribute 616 set for the login account, namely the attribute B has been changed from DisplayName to givenName. Taking the user Alice 103 as an example, the login user name is changed from Alice@dn to Alice@gn. In this case, the value of the attribute B obtained from user information of Alice is the user name Alice@gn, which is different from the login user name Alice@dn in the account association information shown in Table 2. Therefore, account association is not carried out accurately in this state. Furthermore, also in a case where the attribute value of DisplayName in the user information registered with the cloud authentication service has been changed, account association is not carried out accurately as the user name is different from the login user name in the account association information shown in Table 2, similarly to the foregoing. Therefore, it is necessary to update the account association information registered with the multi-functional peripheral 101 to latest information. In view of this, a procedure for dynamically updating the account association information at the time of execution of cloud authentication is executed.

In a case where it has been determined in step S709 that the login user has already been registered with the account association information, the CPU 201 of the multi-functional peripheral 101 determines whether the attribute value of the attribute B of this user is different from the login user name registered with cloud association information in step S715. In a case where the attribute value of the attribute B of the login user in the user information is different from the login user name in the cloud association information as a result of the determination, processing proceeds to step S716; in a case where they are the same, processing proceeds to step S712.

In step S716, the CPU 201 of the multi-functional peripheral 101 executes update processing for replacing the value of the attribute B described in the account association information with the attribute value of the attribute B obtained from the cloud API URL 615 shown in FIG. 6B. As a result, the user name of the cloud print service registered with the account association information becomes consistent with the attribute value of the attribute set as the user name of the cloud print service. After the processing for updating the account association information has been executed, the multi-functional peripheral 101 generates a login context from the obtained value of the attribute B and role information in step S712, and ends login processing.

In a case where the attribute value of the registered attribute B is the same, the multi-functional peripheral 101 does not update the account association information and generates a login context from the obtained value of the attribute B and role information in step S712, and ends login processing.

In the above-described manner, when performing printing that uses the cloud print service, in a case where a login user name of the image forming apparatus is different from a job owner name of a cloud print job, the owner name is converted into or replaced with a login user name corresponding to this owner name. This enables the image forming apparatus to link the cloud print job to the login user.

### Flow of Print Job in Present Embodiment

FIG. 5A is a flow until a print job is printed on the multi-functional peripheral 101 side after the user Alice 103 has transmitted a cloud print job from the PC 102. This is an example of so-called push printing; however, regarding processing of step S5003 onward, the same goes for the case of pull printing. While processing of FIG. 5A is executed by the CPUs of the respective apparatuses, software modules executed by the CPU are shown as the main executors regarding the multi-functional peripheral 101. Note that in FIG. 5A, each “control service” in the multi-functional peripheral 101 shown in FIG. 3 is described as a “control unit” for short. In the flow of FIG. 5A, it is assumed that login processing is executed based on a UPN, which is the attribute 1 described in Table 1, when logging into the multi-functional peripheral 101 and the PC 102, and DisplayName, which is the attribute 2 described in Table 1, is referred to as a display name after the login. Also, it is assumed that a job owner name of a print job transmitted from the cloud print service is the attribute value of the UPN, which is the attribute 1 described in Table 1.

In step S5000, the PC 102 accepts a login operation by a user (in the present example, Alice 103). At this time, the user inputs a user name. The user inputs a password as well. Although omitted in FIG. 5A, authentication information including the user name and the password may be transmitted from the client terminal 102 to the cloud authentication server 104, and user authentication may be performed upon this transmission. The cloud authentication server 104 verifies the UPN attributes of the input user name and user information, and if there is a corresponding record, determines whether a password included therein matches the input password. If they match, the login succeeds; otherwise, the login fails. When the login has succeeded, a response indicating the success is transmitted to the client terminal 102. The response may include a token and DisplayName corresponding to the login user.

When the login has succeeded, a display name on the PC 102 after the login is DisplayName shown in Table 1, which is Alice@dn in the aforementioned example, and this is displayed as a user name of the login user. After the execution of processing for logging into the PC 102, the user Alice 103, who is the login user, inputs to the PC 102 an instruction for processing for transmitting a print job to the cloud print server 105. In step S5001, the PC 102 transmits the print job to the cloud print server 105 in response to the instruction for transmitting the print job. The print job transmitted to the cloud print server 105 is called a cloud print job; for the cloud print job, a UPN is used as a job owner name.

In step S5002, the cloud print server 105 that has received the print job notifies the multi-functional peripheral 101 of job information of the received print job. The multi-functional peripheral 101, which is the notification destination, may be designated at the time of transmission of the cloud print job, or may be determined in advance on a per-user basis, for example. The job information notification is received by the network control service 309 in the multi-functional peripheral 101. In step S5003, the network control service 309 transmits a job obtainment request to the cloud print server 105 in connection with the job indicated by the job information notification.

In step S5004, in response to the job obtainment request, the cloud print server 105 transmits, to the multi-functional peripheral 101, job data held therein for the print job transmitted from the user Alice 103. In response to an obtainment request for a selected job, job data of the selected print job is transmitted to the multi-functional peripheral 101.

The network control service 309 of the multi-functional peripheral 101 that has received the job data confirms the job owner name included in the job data. In step S5005, the network control service 309 notifies the authentication control service 310 of identification information of an attribute that has been set as the attribute used in the cloud print service (e.g., the attribute 1: UPN) and the confirmed job owner name (e.g., Alice). Note that the attribute used in the cloud print service can be specified by referring to the setting value of the item 617 on the setting screen of FIG. 6B. The authentication control service 310 may hold the job owner name received in step S5005 for generation of account association information in later-described step S5105.

The authentication control service 310 that has received the notification saves the attribute used in the cloud print service in the multi-functional peripheral 101, and determines whether the account association information shown in Table 2 includes the job owner name confirmed in the previous process. Specifically, it determines whether the notified job owner name (e.g., Alice) exists in the “user name of the cloud print service” fields in the account association information. In a case where the notified job owner name exists, the authentication control service 310 notifies the network control service 309 of the login user name corresponding to the user name of the cloud print service (e.g., Alice@dn) as the converted job owner name in step S5006.

On the other hand, in a case where the job owner name (e.g., Alice) does not exist in the “user name of the cloud print service” fields in the account association information, step S5007 is executed. In step S5007, the authentication control service 310 does not execute processing for converting the owner name, and notifies the network control service 309 of the notified job owner name (e.g., Alice) as is.

In step S5008, the network control service 309 that has received the job owner name includes the job owner name obtained in step S5006 or S5007 in the job data, and then transmits the job data to the printer control unit. To include the obtained job owner name in the job data, it is sufficient to, for example, rewrite the job owner name accompanying the job data with the obtained job owner name.

In step S5009, the printer control service 307 that has received the job data starts processing for printing the job data. At the time of printing, for example, the job owner name may be displayed on the operation unit 205. Also, although the description of the present flow pertains to direct printing in which printing is executed immediately after the reception of the job data, forced hold printing may be performed in which the job data is forcedly held in the printer control service 307 and print processing is executed after the user Alice has logged into the multi-functional peripheral 101. In the case of the forced hold printing, a transition is made to the following printing flow for a job in a forced hold state.

Note that the procedure of FIG. 5A can be applied to pull printing in which the cloud print server 105 transmits an uploaded print job to the multi-functional peripheral 101 in response to a request. In this case, the following processes are further added to FIG. 5A. First, before step S5002, a user logs into the multi-functional peripheral 101, and a request for job information of a print job of this user is made to the cloud print server 105. Also, between steps S5002 and S5003, the user selects the print job from among print jobs indicated by the job information notification. In step S5003, the multi-functional peripheral 101 transmits a job obtainment request to the cloud print server 105 in connection with the selected print job. In this case, too, step S5004 onward is similar to that of FIG. 5A.

### Printing Flow for Job in Forced Hold State in Present Embodiment

FIG. 5B is a flow in which the user Alice 103 who has logged into the multi-functional peripheral 101 prints a cloud print job that has been input to and placed in a forced hold state in the multi-functional peripheral 101. Processing of FIG. 5B is executed by the CPUs of the respective apparatuses; however, regarding the multi-functional peripheral 101, software modules thereof are shown as the main executors. Note that in FIG. 5B also, each “control serve” in the multi-functional peripheral 101 shown in FIG. 3 is described as a “control unit” for short. Note, it is assumed that the authentication destination at the time when the user Alice 103 logs into the multi-functional peripheral 101 is the “cloud” shown in Table 2, that is to say, the cloud authentication server 104. Also, it is assumed that the user who logs into the multi-functional peripheral 101 is the same as a job owner of the cloud print job that has been placed in a forced hold state in the multi-functional peripheral 101.

In step S5100, the authentication control service 310 of the multi-functional peripheral 101 accepts a login of a user (in the present example, Alice 103). At this time, the user inputs a UPN as a user name included in authentication information. In the case of the user Alice 103, his/her UPN is Alice as shown in Table 1. The user inputs a password as well.

In step S5101, the authentication control service 310 that has accepted the login transmits the input authentication information, namely information of the user name and the password, to the cloud authentication server 104.

In step S5102, the cloud authentication server 104 performs authentication with use of the received authentication information, and notifies the authentication control service 310 of the authentication result. In a case where a response indicating an authentication success has been made as the authentication result, the authentication control service 310 of the multi-functional peripheral 101 transmits a request for obtaining account information to the cloud authentication server 104 again in step S5103. In step S5104, the cloud authentication server 104 that has received the request for obtaining account information notifies the authentication control service 310 of account information of the target user. The account information may include, for example, the UPN, DisplayName, role information, and the like of the login user.

In step S5105, the authentication control service 310 that has obtained the account information executes processing for automatically generating the account association information. In step S5105, step S702 onward in processing of FIGS. 7A and 7B may be executed. Also, in a case where the account information obtained in step S5104 includes values that are equivalent to the attribute A and the attribute B described in FIGS. 7A and 7B (user names) and role information, steps S705, S706, S713, and S714 can be omitted. Furthermore, in a case where account association information is to be newly generated, it is sufficient to use the job owner name that has been received by the authentication control service 310 in step S5005 and held therein as the “user name of the cloud print service” corresponding to the login user name.

In step S5106, the authentication control service 310 executes processing for authentication on the multi-functional peripheral 101. In a case where user authentication has already been performed through cloud authentication, generation of a login context and the like may be performed in step S5106, for example. For example, account information like the user name of the login user, a token received from the cloud authentication server 104, and the like may be included in the login context.

After the processing for authentication on the multi-functional peripheral 101, the authentication control service 310 notifies the printer control service 307 of the login user name “Alice@dn” of the user who has executed the login (e.g., Alice 103) in step S5107.

In step S5108, the printer control service 307 that has been notified of the login user name confirms the print job that has been placed in the forced hold state. Here, it is sufficient to specify the matching print job by, for example, verifying the owner name of the print job that has been placed in the forced hold state and the notified login user name. Here, the job owner name of the cloud print job has been converted into the user name corresponding to the settings of FIG. 6B through processing for converting the user name with use of the account association information. In the aforementioned example, the job owner name of the cloud print job has been converted from the UPN to DisplayName, which is the same attribute as the login user name of the multi-functional peripheral. This enables the multi-functional peripheral 101 to specify the cloud print job owned by the login user based on the login user name.

In step S5109, the printer control service 307 displays, on a user interface (UI) on the operation unit 205 of the multi-functional peripheral 101, the print job which has a job owner name that matches the login user name, and which is standing by for printing. In a case where there are a plurality of applicable print jobs, a list of these print jobs is displayed on the UI. After the user has confirmed the print jobs that have been held in the forced hold state from this UI, the user selects a print job to be printed, and issues a print instruction to the multi-functional peripheral 101. In step S5110, the printer control service 307 accepts this print instruction. In step S5111, the printer control service 307 that has accepted the print instruction starts processing for printing the selected print job.

Note that steps S5101 to S5106 of FIG. 5B may be replaced with the procedure of FIGS. 7A and 7B. This can also realize processing of FIG. 5B.

The above description has been provided in relation to print processing. However, as a job owner name of a cloud print job can be brought into consistency with a login user name, processing linked to the login user name can be executed also in a case where print job management, such as statistical processing and charging processing for the print job, is performed.

In the above-described manner, when performing printing that uses the cloud print service, even in a case where a user name of an image forming apparatus, such as a multi-functional peripheral, is different from an owner name given to a print job, the owner name is converted into the user name of the image forming apparatus corresponding to this owner name. Consequently, the image forming apparatus can specify a cloud print job owned by the login user, and realize processing linked to the user.

### Advantageous Effects of Embodiment Example

The above-described embodiment example can bring a job owner name of a print job obtained through the cloud print service into consistency with a login name used in the multi-functional peripheral 101 without an administrator updating the account association information in advance. Therefore, job count management and job history information management for a print job input from the cloud print service can be performed in operations that are similar to those for a normal print job input via a printer driver.

### Other Embodiment Examples

A technique of the present disclosure can also be realized in processing in which a program that realizes one or more functions of the above-described embodiment is supplied to a system or an apparatus via a network or a storage medium, and one or more processors in a computer of this system or apparatus reads out and executes the program. Furthermore, the technique can also be realized by a circuit that realizes one or more functions (e.g., an ASIC).

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-016287, filed Feb. 3, 2025, which is hereby incorporated by reference herein in its entirety.

What is claimed is:

1. An image forming apparatus that performs user authentication through a cloud authentication server and receives a cloud print job from a cloud print server, the cloud authentication server performing user authentication based on user information, the image forming apparatus comprising:
at least one memory storing instructions; and
at least one processor that is in communication with the at least one memory and that, when executing the instructions, cooperates with the at least one memory to execute processing, the processing including:
generating setting information in which a first attribute and a second attribute are set among attributes included in the user information, the first attribute being used as a job owner name of a cloud print job and the second attribute being used as a login user name;
generating, with reference to the setting information, account association information in which an attribute value of the first attribute and an attribute value of the second attribute are linked to each other on a per-user basis based on the user information; and
replacing the job owner name of the cloud print job with the attribute value of the second attribute linked to the job owner name of the cloud print job in the account association information.

2. The image forming apparatus according to claim 1, wherein
in the generating setting information, the setting information that further includes a setting of an authentication destination that performs user authentication is generated, and
in the account association information, the authentication destination is further linked to the attribute value of the first attribute and the attribute value of the second attribute.

3. The image forming apparatus according to claim 1, wherein
in the setting, a setting screen is displayed, and the setting information in which the first attribute and the second attribute are set is generated on the setting screen in response to a user operation.

4. The image forming apparatus according to claim 1, wherein
in the generating, the account association information is not generated in a case where the first attribute and the second attribute are the same, and the account association information is generated in a case where the first attribute and the second attribute are different from each other.

5. The image forming apparatus according to claim 1, wherein
in the generating, the account association information is generated with respect to a login user who has been authenticated by the cloud authentication server.

6. The image forming apparatus according to claim 5, wherein
in the generating, the account association information is generated by obtaining, from the cloud authentication server, the attribute value of the first attribute and the attribute value of the second attribute in user information of the login user held in the cloud authentication server.

7. The image forming apparatus according to claim 1, wherein
the setting information further includes a setting indicating that the account association information is not to be generated with respect to a user who is prohibited from printing, and
in the generating, the account association information is not generated with respect to a user who is indicated to be a user who is prohibited from printing by role information obtained from the cloud authentication server.

8. The image forming apparatus according to claim 1, wherein
the setting information further includes a setting indicating a user who is not a target of the account association information, and
in the generating, the account association information is not generated with respect to the user who is not a target of the account association information.

9. The image forming apparatus according to claim 5, wherein
in the generating, with respect to the login user, the job owner name of the cloud print job is updated using the attribute value of the second attribute in user information of the login user in a case where the attribute value of the first attribute in the user information of the login user has been registered as a login user name of the account association information, and the attribute value of the second attribute in the user information of the login user has not been registered as the job owner name of the cloud print job.

10. The image forming apparatus according to claim 1, wherein
cloud print jobs obtained from the cloud print server are held in a forced hold state, and printing is performed by executing a cloud print job that has a same job owner name as a login user name of a login user authenticated by the cloud authentication server among the cloud print jobs held in the forced hold state.

11. The image forming apparatus according to claim 1, wherein
the processing further includes managing the cloud print job based on the job owner name of the cloud print job.

12. A non-transitory computer-readable storage medium storing a program that causes a computer of an image forming apparatus to execute processing when loaded to and executed by the computer, the image forming apparatus performing user authentication through a cloud authentication server and receiving a cloud print job from a cloud print server, the cloud authentication server performing user authentication based on user information, the processing comprising:
generating setting information in which a first attribute and a second attribute are set among attributes included in the user information, the first attribute being used as a job owner name of a cloud print job and the second attribute being used as a login user name;
generating, with reference to the setting information, account association information in which an attribute value of the first attribute and an attribute value of the second attribute are linked to each other on a per-user basis based on the user information; and
replacing the job owner name of the cloud print job with the attribute value of the second attribute linked to the job owner name of the cloud print job in the account association information.

13. A control method for an image forming apparatus that performs user authentication through a cloud authentication server and receives a cloud print job from a cloud print server, the cloud authentication server performing user authentication based on user information, the control method comprising:
generating setting information in which a first attribute and a second attribute are set among attributes included in the user information, the first attribute being used as a job owner name of a cloud print job and the second attribute being used as a login user name;
generating, with reference to the setting information, account association information in which an attribute value of the first attribute and an attribute value of the second attribute are linked to each other on a per-user basis based on the user information; and
replacing the job owner name of the cloud print job with the attribute value of the second attribute linked to the job owner name of the cloud print job in the account association information.
